(19) United States
(12) Patent Application Publication
(10) Pub. No.: US 2013/0246138 A1
(43) Pub. Date: Sep. 19, 2013

(54) SYSTEMS AND METHODS PROPAGATING ADVERTISING MATERIALS IN A SOCIAL MEDIA ENVIRONMENT

(71) Applicants: J. Aaron Johnson, Orem, UT (US); Robert G. Adamson, Draper, UT (US); Lani L. Adamson, Draper, UT (US); David Wilson, Spanish Fork, UT (US)

(72) Inventors: J. Aaron Johnson, Orem, UT (US); Robert G. Adamson, Draper, UT (US); Lani L. Adamson, Draper, UT (US); David Wilson, Spanish Fork, UT (US)

(21) Appl. No.: 13/461,540

(22) Filed: May 1, 2012

Related U.S. Application Data
(60) Provisional application No. 61/612,039, filed on Mar. 16, 2012.

(51) Int. Cl. G06Q 30/02

(52) U.S. Cl. 705/14.16

(57) ABSTRACT

A method for incentivizing a user of a social media website to share an offer with others within an online social media environment is provided. The offer includes two coupons, the first coupon having a first value and the second coupon having a second increased value. Sharing of the first coupon provides access to the second coupon and also creates a social media connection between the user and a vendor of the first and second coupons.

### CROSS-REFERENCE TO RELATED APPLICATION

This application claims priority to U.S. Provisional Patent Application Ser. No. 61/612,039, filed on Mar. 16, 2012, the entirety of which is incorporated by this reference.

### BACKGROUND

1. Field of the Invention

The present invention relates generally to incentive programs for promoting and selling products and/or services and more specifically to incentive programs that encourage customers to share such incentive programs with others.

2. Description of the Related Art

The advent of social media platforms accessible via the Internet has greatly expanded over the past decade. FACEBOOK is now the largest such social media cites on the web today, only having been created in 2004. FACEBOOK requires its users to register before using the site. Registered users can create a personal profile and link their account with other FACEBOOK users, known in the FACEBOOK environment as “Friends.”

Each user profile can be individually customized with various photos, lists of personal interests, contact information, and other personal information. Users can communicate with their friends and other users through private or public messages and a chat feature. They can also create and join interest groups and “like pages”, some of which are maintained by organizations as a means of advertising.

FACEBOOK enables users to customize their privacy settings and allow access to their profile only to those other users that they select. Thus, users can control who sees information they have shared, as well as who can find them in searches, through via the FACEBOOK privacy settings. As such, FACEBOOK imposes certain limitations on the ability of users to access other users and to disseminate information to other FACEBOOK users.

FACEBOOK provides its users with a number of features that allow its users to interact with one another. Each FACEBOOK user has access to a “Wall”, which is a space on every user's profile page that allows the user to post messages and images for other user's that are “friends” of the user to see. In addition, users can send messages in the form of “Pokes” that allows users to send a notification that tells a user that they have been contacted by another user. Depending on privacy settings, anyone who can see a user's profile can also view that user's Wall.

Each user's Wall also contains a News Feed that highlights information including profile changes, upcoming events, and birthdays of the user's friends. The News Feed is a continuously updating list of items that appear on a user's Wall and includes postings from other users that are Friends of the user.

Another social media website is MYSPACE. Unlike FACEBOOK, MYSPACE allows users to use HTML and Cascading Style Sheets (CSS) to customize their page. Like FACEBOOK, however, MYSPACE provides a similar feature to the FACEBOOK Wall in the form of a Bulletin Board in which user's can post information in the form of Bulletins to other users, subject to some restrictions. According to COMSCORE, FACEBOOK is the leading social networking site based on monthly unique visitors. FACEBOOK overtook its main competitor, MySpace, in April 2008. FACEBOOK attracted 130 million unique visitors in May 2010, an increase of 8.6 million people. According to ALEXA, FACEBOOK currently ranks second in worldwide traffic. FACEBOOK is the most popular for uploading photos, with 50 billion uploaded cumulatively.

In order for users to connect with things they like and to give positive feedback on a particular item in FACEBOOK, users can indicate that they “Like” something, such as a status update of another user, comments, photos, and links posted by their friends, as well as advertisers. By clicking the “Like” button at the bottom of the content, the content will appear on the user's Friends News Feeds.

The Like button is also available for use on websites outside FACEBOOK. When the user clicks the Like button on another site, a story appears in the user's friends' News Feed with a link back to the website. At the same time when any visitor, including non-Facebook members and logged out users, visit a site with the Like button, their presence on the site is recorded by FACEBOOK. A Like box also allows FACEBOOK page owners to see how many users and which of their friends like the page.

Because of the general structure of FACEBOOK, with a continuously running News Feed where text and photos are shared with Friends by posting to the user's Wall, commercial entities have found use of FACEBOOK in a constructive and profitable manner to be difficult. For example, even though a user may “Like” a particular FACEBOOK page of a particular commercial entity, because the News Feed is continually updating, the link to the “Liked” commercial entity may only appear on the friend's wall for a short period of time. Moreover, commercial entities have not been particularly successful in using the Like feature of FACEBOOK in a manner that encourages user's to continue to share information from the commercial entity to other FACEBOOK users. While the focus of this discussion has been directed to FACEBOOK because of its volume of users, this problem is not limited to FACEBOOK. Indeed, despite the large number of users of social media websites, commercial entities have not been particularly successful in marketing their products or services through the various social media outlets.

Thus, there is a significant need in the art to provide a means for commercial entities and others to create interest in a products, services or events by encouraging users of social media websites to share the content of a particular posting. In addition, there is a significant need in the art to provide such posting in the form of an interactive media form that allows the user to interact with the posting in a manner that encourages them to share the posting with other users of the social media website.

### SUMMARY OF THE INVENTION

Accordingly, the present invention provides a system that utilizes a social media model to propagate advertising materials in a manner that encourages users of a social media website to share the advertising materials.

In a first embodiment, a method for incentivizing a user of a social media cite to share an offer with others within an online social media environment comprises creating a first coupon having a first layout with a first value, creating a second coupon having a second value that is greater than the first value of the first coupon. The second coupon has a second layout that is similar to the first layout. The first coupon is posted to a message board of a first user of a social media website. A first user is allowed to access the first coupon without leaving the social media website. The first user is also allowed to share the share the first coupon with personal connections of the first user by clicking a share button within the first coupon. Once the share button is selected, the first coupon is automatically replaced with a second coupon. The second coupon is only accessible to the first user as a reward for sharing the first coupon.

The first coupon is automatically shared with the personal connections of the first user when the first user clicks the share button. Once shared, the first coupon is then automatically posted on the message boards of each of the personal connections of the first user. Each of the personal connections then has access the first coupon without leaving the social media website. The group of personal connections can then share the first coupon with their personal connections by clicking the share button of the first coupon. Doing so, will replace the first coupon with the second coupon and thus allow the group of personal connects that shares the first coupon to have access to the second coupon. Each successive time that the first coupon is shared results in the first coupon being propagated to additional users of the social media website that have a connection with the user that has shared the first coupon. When propagated, the first coupon will appear on the message board of the additional users. When shared, each user who shares the coupon will be given access to the upgraded and/or higher value coupon that provides the incentive for sharing the coupon. For example, the first coupon may provide a ten percent discount on a product or service whereas the second coupon man provide a twenty percent discount on the product or service.

As the coupon is shared, the vendor can track the number of times that the coupon has been shared in order to determine the effectiveness of the coupon campaign.

After a vendor has created the first and second coupons, the vendor can post the coupon to any user that has previously authorized the vendor to send information to the first user through the social media website. In addition, each time a new user that was not previously associated with the vendor shares the first coupon, that new user is automatically connected to the vendor so that the vendor can post additional coupon offers directly to the new user.

In each instance, when viewing either the first or second coupons, the user views and can download, print or display the coupon within the social media website without being directed out of the particular social media website.

In addition, when a user shares the first coupon, the second coupon automatically replaces the first coupon. In one embodiment, the first coupon is visually transformed into the second coupon within the web browser window where the user is viewing the first coupon.

In order to create the first and second coupons, a coupon generating software application is accessible by the vendor for creating the first and second coupons. The software application provides a user interface with user selectable coupon templates that allow the vendor to create the first and second coupons and post the first and second coupons to the first user of a particular social media website.

### BRIEF DESCRIPTION OF THE DRAWINGS

FIG. 1 is a graphical representation of a display device having an incentivized digital coupon displayed thereon in a social media environment in accordance with the principles of the present invention.

FIG. 2 is a graphical representation of an alternative embodiment of an incentivized digital coupon for being displayed on a display device in accordance with the principles of the present invention.

FIG. 3 is a flow diagram of a process for distributing an incentivized coupon in accordance with the principles of the present invention in a social media environment.

FIG. 4 is a graphical representation of a computer software program displayed on a display device of a computer for creating an incentivized coupon in accordance with the principles of the present invention.

FIG. 5 is a graphical representation of the computer software program displayed on a display device of a computer for creating an alternative embodiment of an incentivized coupon in accordance with the principles of the present invention.

FIG. 6 is a graphical representation of a user page of a social media website displayed on a display device of a computer in which an incentivized coupon according to the principles of the present invention is displayed and accessible by the user.

FIG. 7 is a graphical representation of a pre-share coupon displayed within a social media environment and accessible by a user of the social media website.

FIG. 8 is a graphical representation of a post-share coupon displayed within a social media environment and accessible by a user of the social media website.

FIG. 9 is a process flow diagram for creating and sharing a pre-share coupon with a user of a social media website in accordance with the principles of the present invention.

When considered in connection with the following illustrative figures, a more complete understanding of the present invention may be derived by referring to the detailed description. In the figures, like reference numbers refer to like elements or acts throughout the figures.

### DETAILED DESCRIPTION OF THE INVENTION

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶ 6. Thus, the use of the words “function,” “means” or “step” in the Detailed Description of the Invention or claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. §112, ¶ 6. Moreover, even if the provisions of 35 U.S.C. §112, ¶ 6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Various aspects of the present invention may be described in terms of functional block components and various processing steps. Such functional blocks may be realized by any number of hardware or software components configured to perform the specified functions and achieve the various results. Various representative implementations of the present invention may be applied to any social media system.

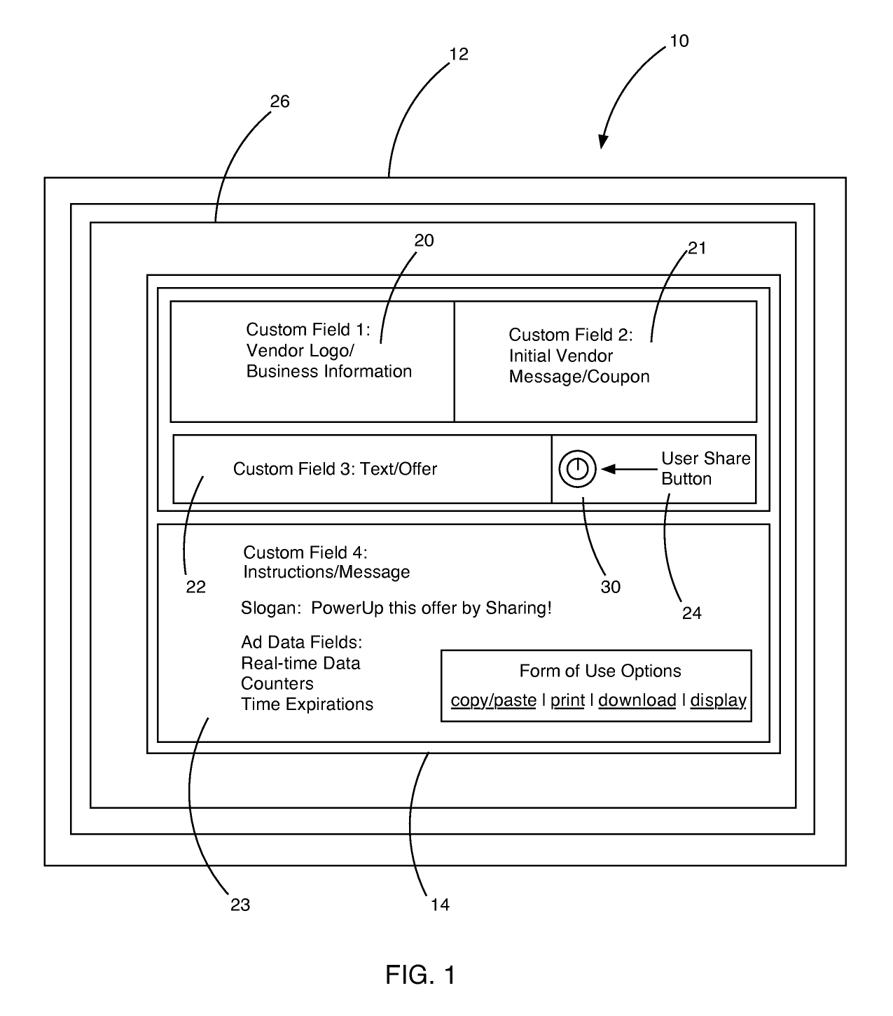

Referring now to the figures, FIG. 1 is a schematic representation of a custom digital coupon, generally indicated at 10, displayed on a display device 12, such as a computer monitor, tablet, handheld device, such as a smart phone, or other display device known in the art in accordance with the principles of the present invention. In the case of a computer monitor, the display device 12 may be coupled to a computer running an operating system such as MICROSOFT WINDOWS, APPLE MAC OS, LINUX or any number of open source operating systems, or may be incorporated into a portable computing device such as an IPAD, IPHONE, ANDROID or other portable or handheld computing device. More particularly, the digital coupon is configured for being displayed within an Internet browser window 26 displayed on the display device 12, such as MICROSOFT EXPLORER, APPLE SAFARI, GOOGLE CHROME or FIREFOX web browsers or other web browsers known in the art. Even more particularly, the digital coupon is displayed on the computer monitor 12 through a web browser that is directed to and displaying content from a social media website of which the user is a member. For example, the digital coupon is displayed on a FACEBOOK, MYSPACE, GOOGLE+ or other social media website that allows users to share information to other members of the social media website. It should be noted that the type of operating system, Internet browser and/or social media website used to display the digital coupon 10 is not important so long as such operating system, Internet browser and social media website is capable of displaying the information, images and links that form the basis of the coupon 10 so that the user can view the digital coupon and interact with it via an on-screen cursor through a user input device, such as a mouse, trackpad or other computer input device.

The digital coupon includes a frame 14 within which are provided a plurality of customizable fields 20, 21, 22 and 23 as well as a user selectable share option 24. The frame 14 forms a boarder within which the coupon is provided. The frame 14 can be provided in the form of a preset template with certain preset customizable fields 20-23. For example and not by way of limitation, the customizable fields 20-23 may include a first custom field 20 within which a vendor logo and business information can be displayed for the user to allow the user to quickly identify the source of the coupon 10. A second customizable field 21 may include an initial vendor message and coupon information. A third customizable field 22 may include terms and conditions of the offer in the form of text. A fourth customizable field 23 may include instructions for redemption, additional messages, slogans, links to copy/paste, print download and/or display the coupon 10 as well as various data fields for tracking the coupon 10 as it is used and shared. As will be described in more detail herein, the customizable fields 20-23 are customizable by a vendor prior to posting to the user's social media account. Once posted, however, the coupon 10 cannot be altered by the user.

In order to encourage a user to share the coupon 10 with other computer users, the fourth customizable field 23 may include an additional incentive to the user to share the coupon 10. In order to increase the value of the coupon 10, the user must share the coupon by selecting with a user input device, such as a user controlled cursor, the Share button 30.

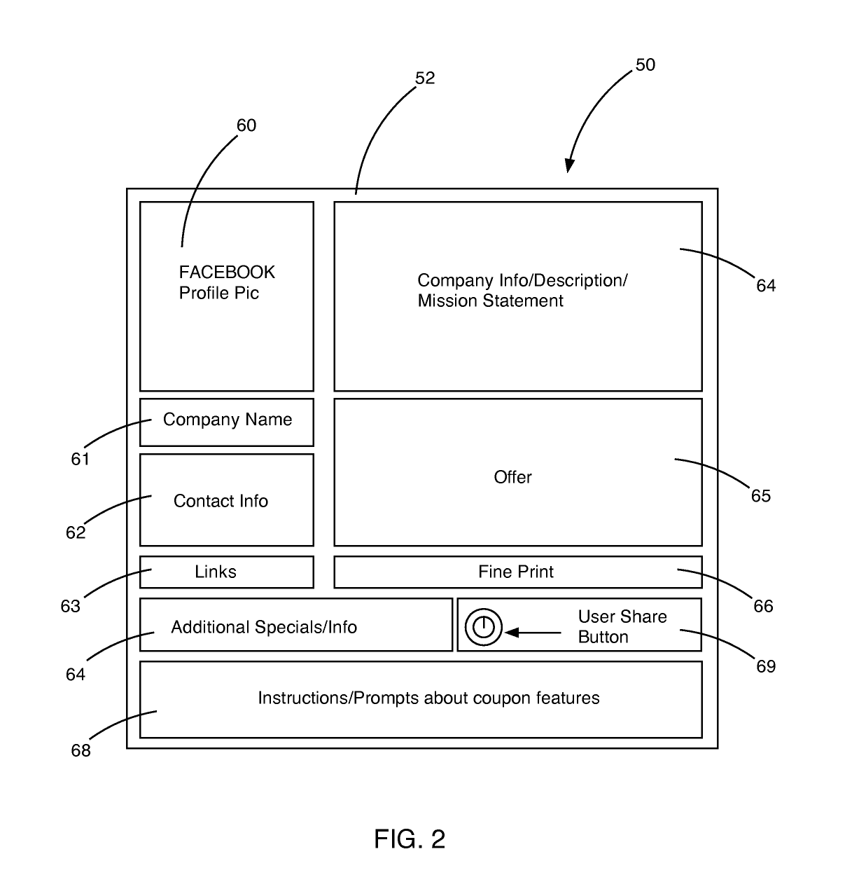

Prior to posting a digital coupon according to the present invention, the vendor has the option of selecting from a plurality of coupon templates, each of which may have a different layout and/or options for various content. For example, as shown in FIG. 2, a digital coupon, generally indicated at 50 is comprised of a frame 52 within which various fields 60-69 is provided. Each field 60-69 is provided to contain particular information or content associated with the vendor or its offer, such as pre-designed corporate ads that can be uploaded and incorporated into the digital coupon. In this embodiment, the digital coupon has been particularly configured to work with the social media website FACEBOOK. However, those of skill in the art will appreciate after review of the present invention that the principles discussed herein could be adapted to work with other social media websites such as MYSPACE, GOOGLE PLUS, LINKEDIN, and others. Thus, while the present invention makes reference to specific social media websites, such as FACEBOOK, such reference is by way of example and not by limitation. Because companies are allowed to create and operate an account through FACEBOOK, the vendor's FACEBOOK profile contains certain information that can be extrapolated from the vendor's profile and used in the digital coupon 50. For example, the vendor's FACEBOOK profile picture can be uploaded into the field 60. Likewise, the company name, contact information and link to the company website can be pulled from its FACEBOOK profile and added to fields 61, 62 and 63, respectively. In addition, other company information, description of goods or services and/or mission statement can be included in field 64 by the vendor. The field 64 could also include various text, photos or video that can be provided in the coupon 50 that is related to the offer as desired by the vendor. The offer is then provided in field 65 along with terms and conditions for the offer in the Fine Print field 66. Any additional specials or information that will encourage the user to share the coupon 50 is provided in field 67, with instructions and/or prompts about the coupon 65 are provided in field 68.

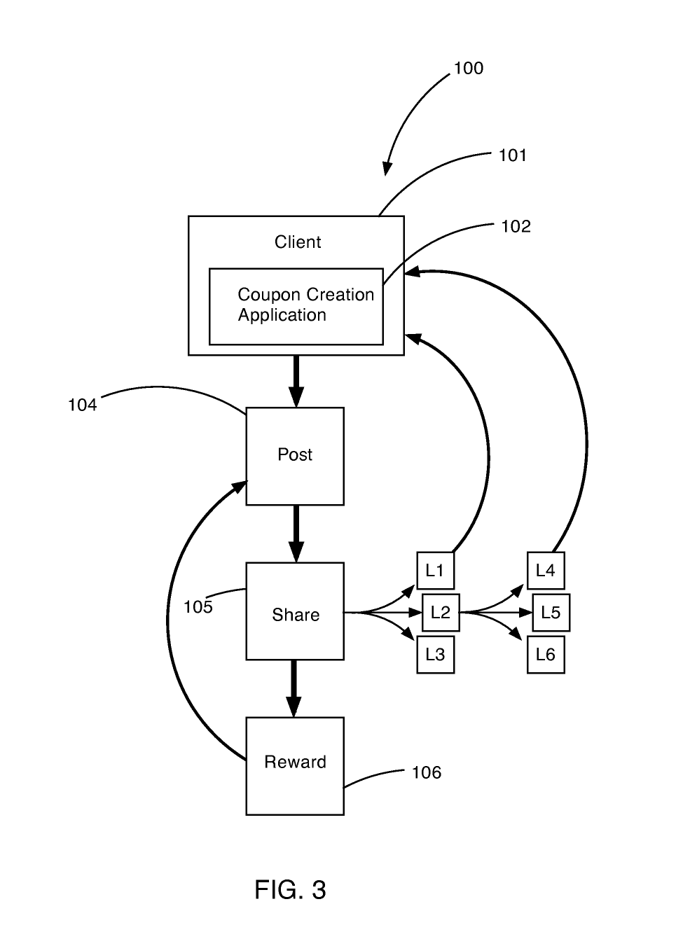

As shown in the schematic block diagram of FIG. 3, a method of dissemination of coupons generally indicated at 100, which may include special offers of a vendor, encourages users to disseminate the coupon by “sharing” or “liking” the coupon or emailing the coupon to other members of a social media website or other contacts of the user. In a FACEBOOK setting, although other social media settings could be used, the client (i.e., vendor) will have a group of users that have previously “liked” the vendor. The “Like” feature in FACEBOOK allows a vendor to share content of their FACEBOOK page, link post or website with other users. When a user clicks the Like button on a vendor website or within FACEBOOK for a particular entry that appears in a user's News Feed, a story appears in the vendor's friends' News Feed, typically with a link back to the vendor's website.

Once a user “Likes” a particular vendor by clicking a “Like” button for that vendor, a connection is made between the vendor's page (website or FACEBOOK page) and the user. The vendor's page will appear in the “Likes and Interests” section of the user's profile, and the vendor will have the ability to publish information to the user. The vendor's can then target ads to people who like its content. The use of the Like button in FACEBOOK is the manner in which content is shared between users of FACEBOOK. That is, whenever a FACEBOOK user “Likes” a website, FACEBOOK entry or other content, a story with a link to that website, FACEBOOK entry or other content automatically appears in the News Feed of each “friend” of the user. This is how content is typically shared between FACEBOOK users, in addition to any original postings that a user may create and post to the user's “friends.”

Thus, once a user “likes” a vendor, the user is considered a “fan” of the vendor and the vendor is able to send messages and other content to the user's News Feed that will appear on their Wall (i.e., message board). Until now, while vendors may have thousands of “Fans” that have “Liked” their website or Facebook page, vendors have not been effective in using these “Fan” connections to market their business. It has also been the case that vendors have found it difficult to expand their fan base through their existing fan connections. The present invention utilizes a vendor's fan base not only to disseminate information and offers to its fans, but also to motivate fans to share the vendor's content to each fan's friends.

According to the present invention, the vendor creates 101 an incentivized coupon via a Coupon Creation Application 102. Once the incentivized coupon is created, it is posted 104 to the News Feed of fans of the vendor. The coupon includes an incentive to motivate the fan to share 105 the coupon with friends of the user. Specifically, as previously discussed herein, the coupon includes a button that, when clicked by the user, has two effects. First, the pre-share version of the coupon as first viewed by the user will be posted 104 to each of the users friends by being delivered to the News Feed of each fan. Second, when the fan shares the coupon with other users that are “friends” of the fan by clicking the button, the fan will obtain a reward 106 in the form of an upgraded coupon, which may include additional or increased benefits. As will be described in more detail, rather than having a new posting of a new coupon appear in the News Feed of the fan, which is also a possible way to provide the reward coupon, when the share button is clicked, the incentivized coupon will visually transform into the reward coupon in which the upgraded offer is provided to the fan as a reward for sharing the coupon with the fan's friends.

As further illustrated in FIG. 3, when the user (fan) shares 105 the coupon with other users (friends) L1, L2, L3 by clicking the share button, the coupon is automatically disseminated to each friends' L1, L2, L3 News Feed. If the friend then Likes the coupon by sharing with other friends L4, L5, L6, the friends then become additional fans of the vendor and receive the reward coupon as well. This process can be repeated any number of times until the coupon expires or a coupon propagation number limit has been reached, which can be controlled by the vendor when creating the incentivized coupon. Because the number of “Likes” for a particular coupon can be tracked through FACEBOOK, the success of a coupon campaign can be tracked. That is, the vendor can monitor the success of the FACEBOOK campaign by monitoring the number of Likes in real-time. If a particular coupon is not being shared by fans to the extent desired, the vendor can change the content of the coupon in order to increase the distribution of the coupon.

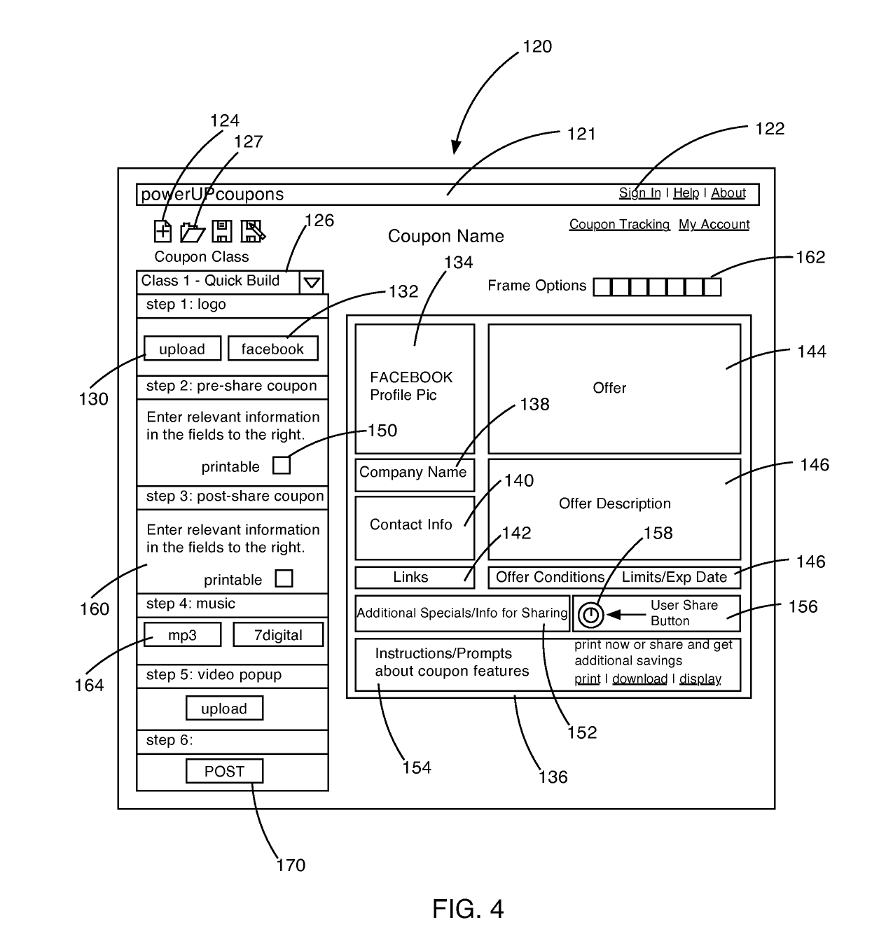

FIG. 4 illustrates a user interface, generally indicate at 120, of a computer software program 121 in accordance with the principles of the present invention. The user interface 120 is displayed on a computer monitor or other display device of a user in which the user can interact with the program to enter information and create a desired coupon. In a web-based scenario, the interface 120 is provided within a window of a web browser and includes a login feature 122 in which a user can input a user name and password to access the program. Once signed in, the user can then create a coupon by selecting the “New” icon 124 or opening a previously created coupon by selecting the “Open” icon 126. Icons for saving 127 and “saving as” 128 are also provided so that a user can save the coupon under a particular Coupon Name that is displayed at the top of the software window. Coupon tracking is also provided in which the user can track use and dissemination of the coupon once created and sent to its fans through the social media website, such as FACEBOOK. Also, the user will have an account under the My Account link, in which the user can provide payment information, change user settings, and enter user information for the account that can be used within the coupon fields when creating a coupon.

From a menu 128 on the left of the screen, the user can select the type of coupon to build, with each type providing a coupon template with various features and layouts. In this illustration, a “Quick Build” option has been selected by the user. Using the Quick Build coupon option, the first step is for the user to select an image that identifies the vendor, such as a company logo or FACEBOOK profile picture. By clicking the upload button 130, the user can select an image that is stored on their computer or computing device. By clicking the FACEBOOK button 132, the application will automatically retrieve the user's FACEBOOK picture and insert the image into the FACEBOOK Profile Pic field 134 in the coupon 136. In addition, the user can input the company name in the Company Name field 138, the user's contact information in the Contact Info field 140 and links to the user's website and/or FACEBOOK page in the Links field 142. This information can be uploaded automatically from the user's FACEBOOK profile and/or modified by the user prior to posting the coupon.

In a second step, the pre-share coupon is created when the user enters the offer and offer description in the Offer and Offer Description fields 144 and 146, respectively. Also, various offer conditions, such as limits on use (e.g., “one coupon per customer”), expiration date and other terms and conditions can be entered in the Offer Conditions field 148. Also, in step 2, the user can select whether the coupon is printable by clicking the box 150. Also, the user will enter any additional specials or information for sharing the pre-share coupon to friends of the user. This information will be entered into the Additional Specials/Info for Sharing field 152. Other instructions can be entered into the Instructions/Prompts field 154 by the user. For example, this content sensitive area can be utilized to guide the end user through the process by providing specific instructions for use and/or increasing the value of the coupon. Other static features, such as the ability for a coupon user to print, download or display the coupon, are also provided in the Instructions/Prompts field 154. For example, when the customer selects the “print” option, the coupon will automatically be transformed into a PDF template or other printable format so that the customer can print and take the coupon with them. Likewise, the User Share Button field 156, which includes a clickable button 158, is also a static feature that is included in the coupon, but cannot be changed by the user. A customer can print the initial coupon offer or share the coupon by clicking the button 158 to access the post-share coupon for additional savings or promotions. Thus, the share button 158 initiates a share with permissions to allow the coupon to be automatically shared to the user's social media connections, such as “friends” in FACEBOOK. In addition, once the button 158 is clicked, the frame 136 of the coupon can morph in color, design, sound and/or video so that the post-share coupon is distinctly different from the first pre-share coupon. This morphing procedure can be accomplished with ADOBE FLASH or other such software known in the art.

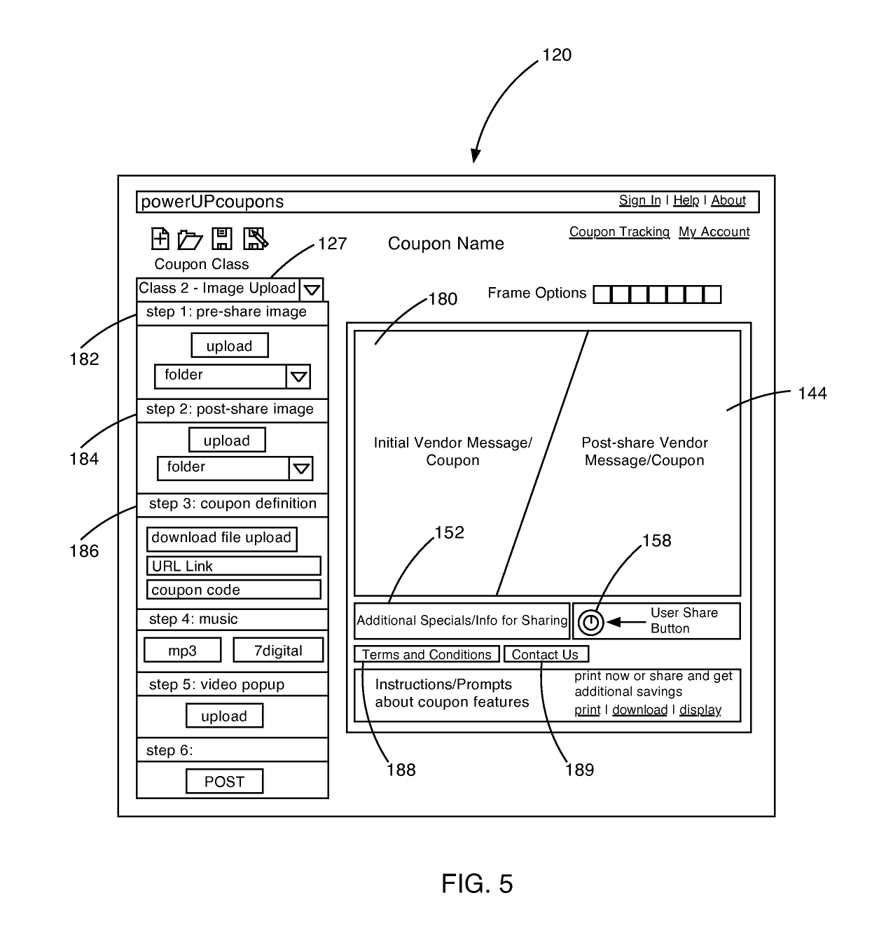

As illustrated in FIG. 5, the user has selected Class 2—Image Upload as the Coupon Class 127. This allows the user to insert a pregenerated coupon 180 into the Offer field 144. For example, some companies have advertising agencies create coupons for various mailed coupons. Rather than recreating such coupons for use with the present invention, the user could simply obtain a copy of the coupon in digital format and import the image of the coupon into the Offer field 144. Most often, such coupon images already have company information, contact information and a particular offer. Thus, step 1 182 is to upload the pre-share coupon image as by selecting the pull-down menu in which folders on the user's computer are displayed so that the user can select the desired coupon image. Similarly, the user can upload a post-share coupon image from their computer in step 2 184. As illustrated in the Offer field, the Post-share Vendor Message/Coupon will be displayed in the same filed as the Initial Vendor Message/Coupon, but will not be visible until the user selects the Share button

In the third step, the user creates the post-share coupon. In the third step 160, the coupon will basically remain the same except for information in the Offer field 144, Offer Description field 146 and the Additional Specials/Info for Sharing field 152, since those fields deal with the pre-share offer. Once the post-share coupon is displayed, the user can enter information into fields 144, 146 and 152 that specifically deal with the post-share offer. In addition, the user can select different frame options 162 which may include various color schemes for the frame 136 of the coupon. In other words, the pre-share and post-share coupons may have different color schemes so that when the coupon user shares the pre-share coupon, the color of the coupon changes when displaying the post-share coupon 158. In other words, when the share button 158 is clicked, the Initial Vendor Message/Coupon will be replaced with the Post-share Vendor Message Coupon. Thus, the user will specify two images, one for being displayed before sharing and one for being displayed after sharing, liked or emailed.

For the Image Upload coupon, step 3 186, the user can select a data file with the various data for the offer including a URL Link of the user and/or a coupon code that can be used by the end user when making an online purchase, for example. In addition, other links 188 and 189 can be provided for providing terms and conditions for use of the coupons as well as contact information for the user. Vendor specific language and other offer specific text can be added to the Additional Specials/Info for Sharing field 152.

If desired, the coupon can be transformed into a multi-media experience for an end user by adding audio by clicking the mp3 button 164 in which the user can upload an audio track, such as a mp3 music track, or by clicking the 7digital button in which the user can upload mp3 music from 7digital.com. Likewise, as set forth in step 5, the user can add a video file to the coupon to add a video element to the coupon that can be combined with the audio track. Of course, other multimedia files in various formats and services providing such multimedia files could also be included and utilized. Reference to specific file formats and services are by way of example and not by limitation. Both the audio and video files will appear in the coupon when displayed on the social media site, such as FACEBOOK. Once the user completes the coupon, the user can then click the post button 170 and make the coupon available for sending out to fans of the user.

Under the Coupon Class menu 127 are a number of options that can be selected by a user. The first option is the Quick Build option previously described. Other options include Class 2—Image Upload, as described with reference to FIG. 5, Class 3—Code, Class 4—Power Build, Class 5—Serialized, Class 6—PrePurchased and Class 7—Sold. In each different class, the interface for the user will be modified for the particular type of coupon being created. In addition, objects and data for a particular coupon style will be collected and entered based on the specific coupon type and usage selected by the user. In the case where the vendor selects Class 3—Code, the vendor will be able to create an incentivized coupon in which one or more codes are provided to users that can be redeemed by the user for a discount, free shipping, or other promotion. The codes can be codes that are used in the online ordering of products or services or that can be used at a store by presenting the code at the point of sale. In the case where a vendor creates a Class-4 Power Build coupon campaign, the vendor is provided with a preconfigured coupon template in which the vendor need only input the pre- and post-share offers and the coupon is automatically generated for the vendor. Where the vendor selects Class 5—Serialized, the vendor can create an incentivized coupon in which the user is presented with coupons that may be specifically numbered or serialized to allow the vendor to control the number of coupons that can be redeemed. Likewise, the serialized coupon can limited to a set number shares by users to other users such that once the number of shares between users has been exceeded, the coupon can no longer be distributed to other users and become automatically inactive. This coupon expiration triggering is accomplished by the present invention by tracking the number of shares by users of the coupon and terminating the coupon campaign once the predetermined number of shares has been reached. For coupons built using Class 6—Pre-Purchased, the user can actually complete a purchase transaction using the coupon campaign in order to pre-purchase a good or service through the coupon system, after which the user is provided with a voucher that allows the user to obtain the good or service with the voucher. For example, a vendor could provide users with the ability to purchase a pre-share voucher for a service, such as window cleaning, in which the user is given a discount from the regular service price. If the user shares the voucher with other users, the user is given access to a second voucher in which the discount for the service has been increased. Once the user purchases the voucher, the user can print the voucher, contact the vendor to schedule the service and present the voucher to the vendor in order to receive the post-share discount. Similarly, when a vendor creates a Class 7—Sold coupon, the vendor can provide the user with the opportunity to purchase the product directly through the coupon system of the present invention. Additional aspects of the invention regarding the use of a Class 7 coupon campaign are described in more detail herein.

As further illustrated in FIG. 13, the vendor may be provided with a software program according to the principles of the present invention in which a customizable layout for generating an incentivized coupon can be created. The software program is displayed in a window 190 on a computer screen. A menu 191 is provided on the left side of the window 190 in which various components of the coupon are selectable and modifiable by the vendor. For example, the list of components that can be added to the coupon may include photos, backgrounds, frames, images, shapes, videos, audio, FACEBOOK information, text and the “powerup” features that allow for increasing the incentive and options for emailing, printing and/or texting the coupon. As shown by the cursor 192 each customizable field within the coupon window 193 can be moved, sized and shaped according to vendor desires. Each piece of information or content of the coupon can be provided in a specific layer, as illustrated in the layer and view menu 194. For example, each of the contact information, message, details, deal, post-share, expiration date, fine print, details, and share deal can be provided in separate layers and viewed separately within the coupon by selecting that particular layer and a view that only contains the desired content to be displayed. Thus, one or multiple fields can be independently displayed as the vendor builds the particular coupon. Various other editing features 195 are provided, such as undo, redo, delete, cut, copy, paste, top justify, bottom justify, left justify, right justify, space horizontally, space vertically, move to front, move to back, constrain proportion when resizing and change the opacity. These editing features 195 work with any selected object within the coupon, whether it is an image, field or any other selectable content provided in the coupon. Once the coupon has been created and saved, the coupon can be uploaded to the provider's website that has a direct link to the social media site for which the coupon has been generated, in this example FACEBOOK.

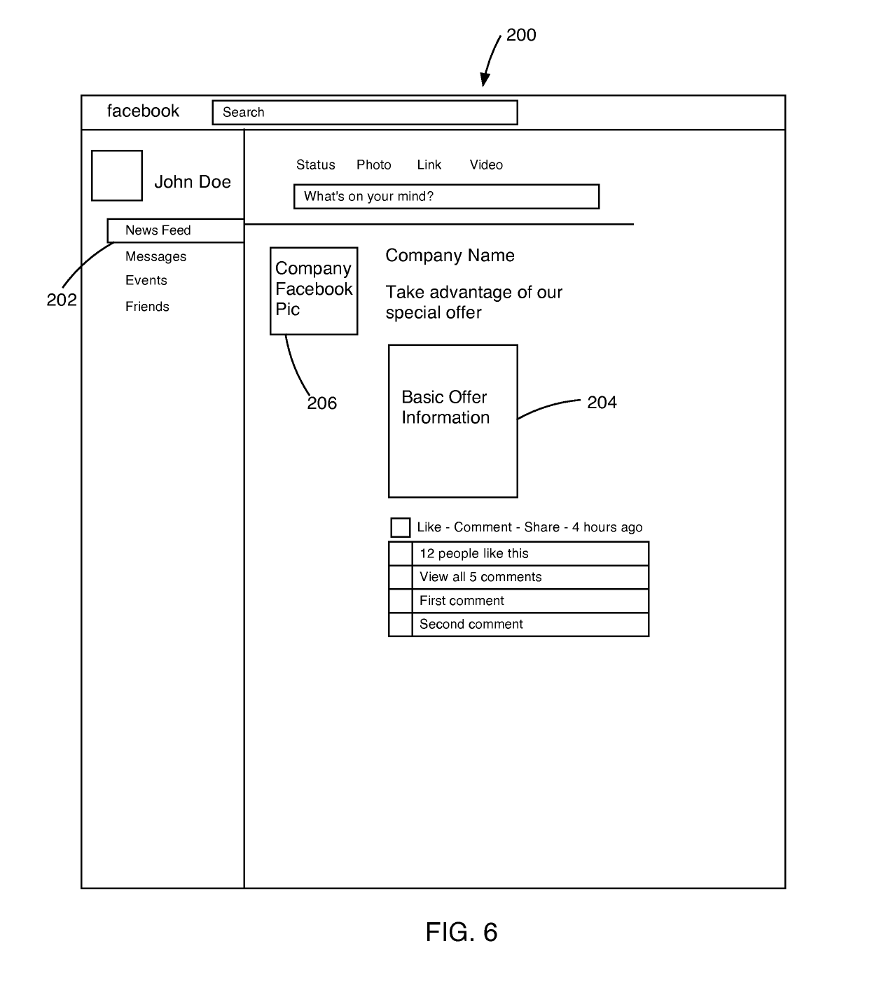

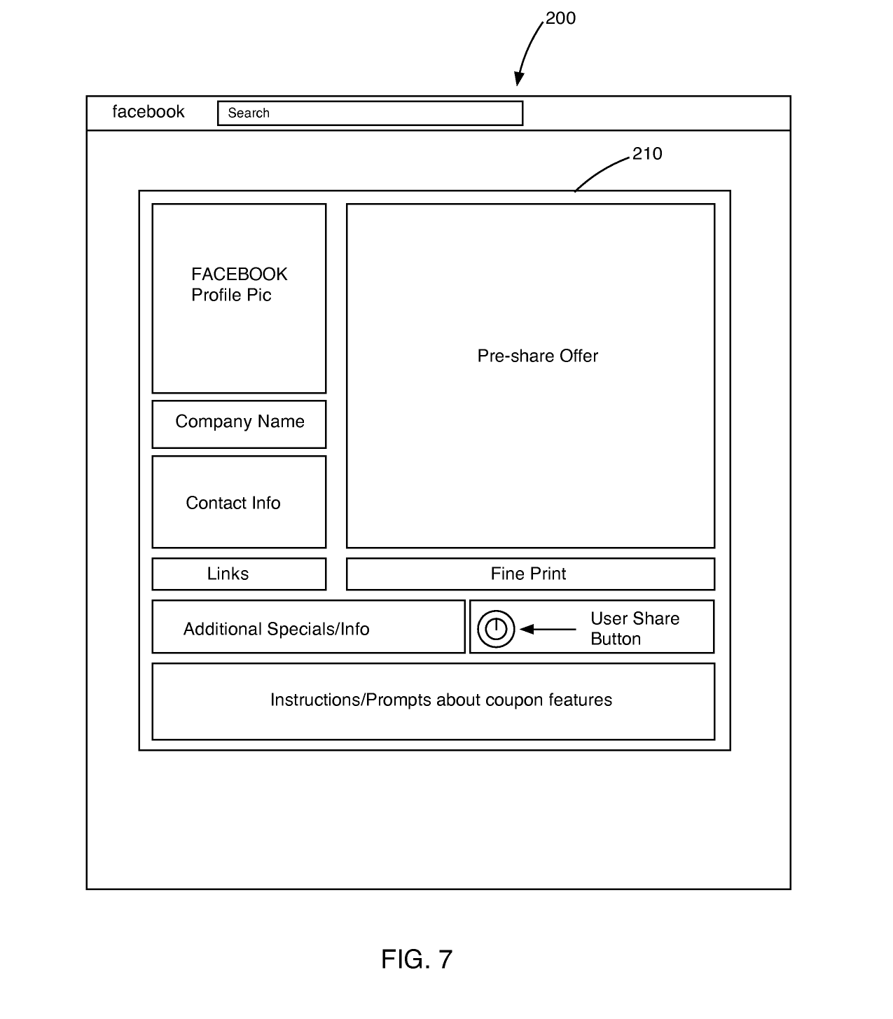

As shown in FIG. 6, when a coupon according to the principles of the present invention is posted to FACEBOOK page 200, and more specifically to the Wall of a FACEBOOK user through their News Feed 202, an image 204 with the basic offer information will appear as well as the company's profile pic 206, company name, and any comment that has been added by the company such as “Take advantage of our special offer.” If the FACEBOOK user wants to view the coupon details and clicks the image 204, the user will be given access to a new page, as shown in FIG. 7, that will display the pre-share coupon 210. Rather than taking the user out of the FACEBOOK environment and directed to another website, whether that be the vendor's website or website of the company that generated the coupon, however, the coupon 210 will be displayed within the FACEBOOK environment. In other words, the coupon system of the present invention is configured to provide the coupon content to the potential customer without forcing the potential customer and FACEBOOK user to leave the FACEBOOK environment to view and/or interact with the coupon. It is contemplated that the coupon can be hosted on a third party website while appearing to be within the FACEBOOK environment. Essentially, the coupon operates within a third party window within a social media environment. Thus, the user will not necessarily know that they are connecting to a third party website to view the coupon. This has a tremendous advantage over other typical forms of advertising on FACEBOOK in which user's are immediately directed out of FACEBOOK to a third party website when viewing advertising material. Indeed, it is often the case that FACEBOOK and other social media users do not want to be directed out of the social media site without intending to do so. Attempts by vendors to do so can be frowned upon by social media users since they may feel that they have been tricked into visiting a vendors website. With the present invention, however, from the user's perspective, they remain within the social media environment while they decide whether to accept the offer or not and whether they are going to share the coupon with their social media connections. Of course, the coupon of the present invention could be completely hosted and viewable on a third party website, even though directing the user out of the social media environment from which they accessed the coupon.

Hosting the coupon on a third party website, while appearing to be within the social media environment also allows the third party to track, in real-time, the use and dissemination of the coupon. That is, every field within the coupon that the user can select by clicking can be tracked by the third party, or any other party with access to the data received by clicking on a particular field within the coupon. For example, as a user clicks the Share Button, the third party will know that the Share Button for that particular coupon was selected by the user. By accumulating such clicks by various users, the third party can track exactly, and in real-time, how many times the coupon was shared by users. The third party can also track how many times the coupon was viewed, printed, emailed or even how many times the coupon was used to access the vendor's website by tracking the number of times the vendor's URL was clicked to access the vendor's website. As such, the vendor, when given access to the tracking information, can quickly determine the success of a particular coupon campaign by viewing various analytical information that is tallied as the coupon is distributed by users. This information may include the number of views of the coupon, the number of impressions (number of times the coupon was posted to a unique user), the number of shares, likes, emails, texts, etc. as well as the number of times each individual clickable field in the coupon, such as the logo, photo, url, pre-share banner or post-share banner were clicked. In addition, such analytics can be collected and displayed for either of the pre-share coupon or the post-share coupon, or both. Such information can be displayed for any given time period. In this way, the vendor can track the progress of the coupon campaign at any given time and see how well the coupon campaign is progressing. In addition, the vendor can track the number of coupon redemptions by linking their internal purchasing system to the analytics software of the present invention so as to also be able to track the number of times that the coupon has been redeemed by a user, the number of new customers that have redeemed the coupon and the estimated revenue generated from the coupon redemptions. As such, the vendor is able to determine the success of the coupon campaign in actual dollars generated from the coupon campaign.

In the case of serialized coupons in which a unique serial number is provided for each coupon, additional analytical information can be tracked, such as the number of potentially unique customers have redeemed the coupon. In addition, when a serialized coupon campaign is employed, the vendor can limit the number of coupons that can potentially be redeemed by limiting the number of coupons that can be provided to users. The system can be configured to limit the number of times that a particular coupon is shared with other users. Once the limit is reached, the coupon campaign is terminated.

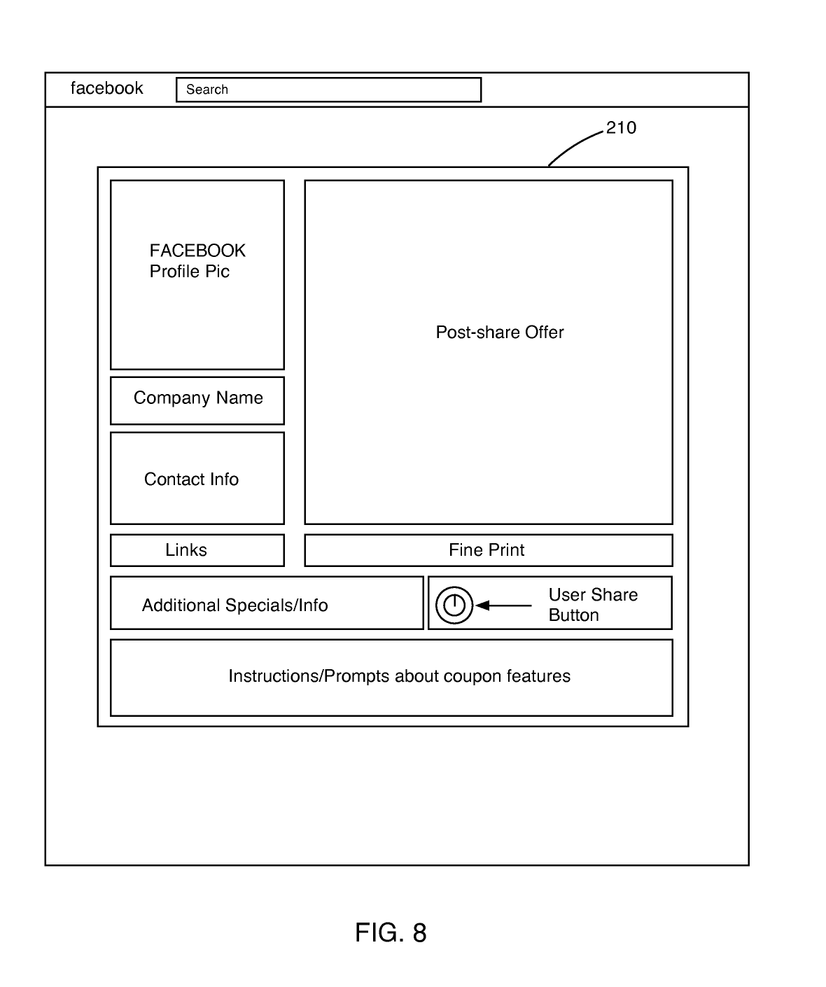

Once the social media user decides to share the coupon 210 as shown in FIG. 8, the user is then automatically provided with the post-share version of the coupon that has been previously created by the vendor. Once the share button is pressed, the coupon 210 will automatically transform or morph into the post-share version of the coupon. Once shared, the user's social media connection will automatically receive a posting on through their News Feed that the user likes the offer that has been shared. The new posting will appear on the user's friends Walls in a manner similar to that shown in FIG. 6. The new user will then have the opportunity to view the pre-share coupon as shown in FIG. 7 and, upon sharing with other users, may have the opportunity to upgrade the coupon to the post-share version, depending on parameters set by the vendor of the coupon in creating the coupon. In addition, when a new user share's the pre-share version of the coupon, they will then automatically become a fan of the vendor, which allows the vendor to directly post new offers to the News Feed of the new user. As such, the present invention not only allows and encourages sharing and thus propagation through a social media website advertising materials in the form of coupons, the present invention potentially increases the number of connections to which the vendor can subsequently directly communicate to new customers as their coupons are shared. Furthermore, as each coupon of a particular vendor is shared, the vendor can track the number of times that the coupon has been shared, how many times a coupon has been redeemed and how many new contacts that the vendor has generated. Thus, the overall success of a particular coupon campaign can be tracked in real time and monitored throughout the campaign in order to determine the overall success of the advertising campaign in place.

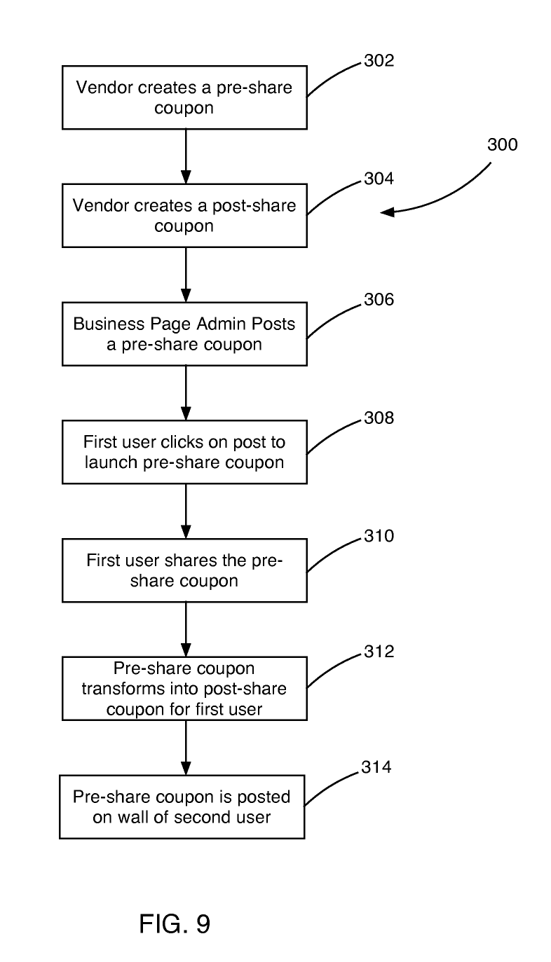

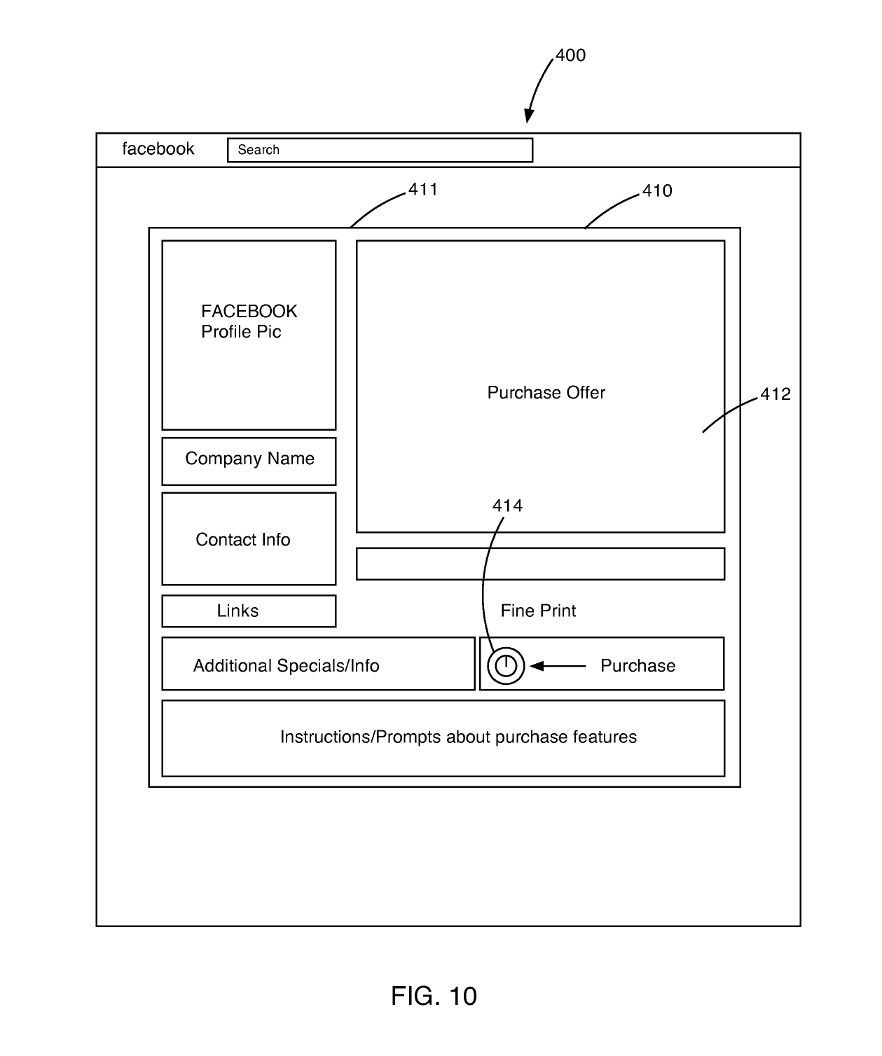

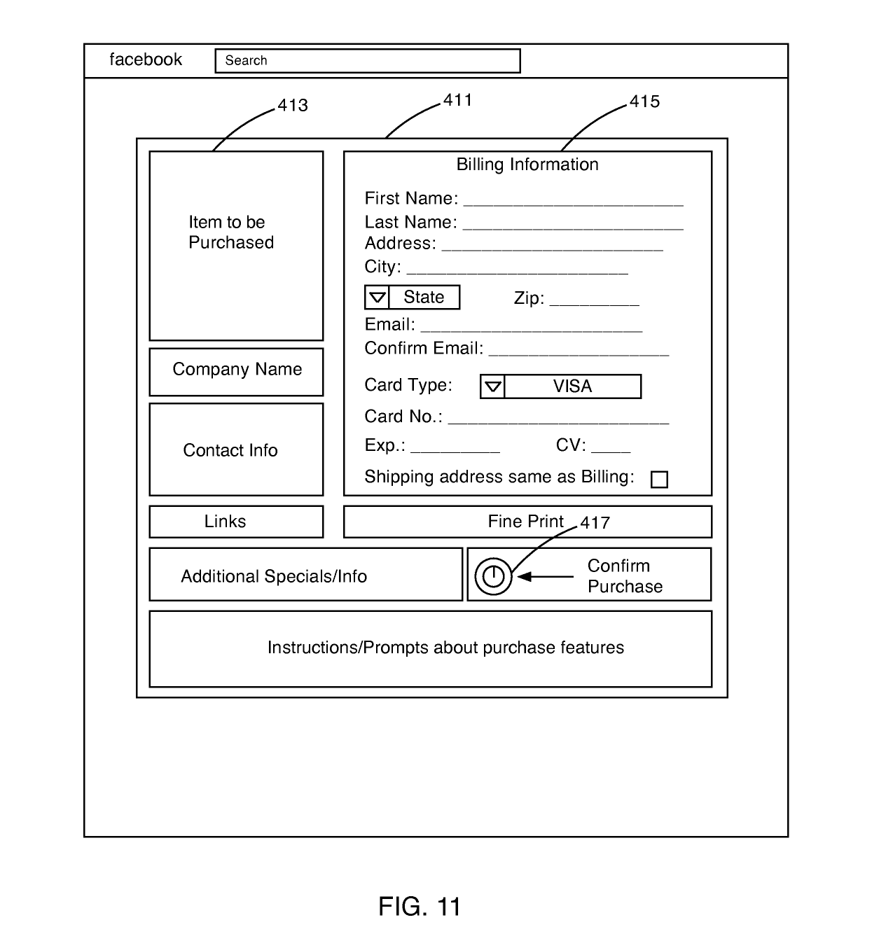

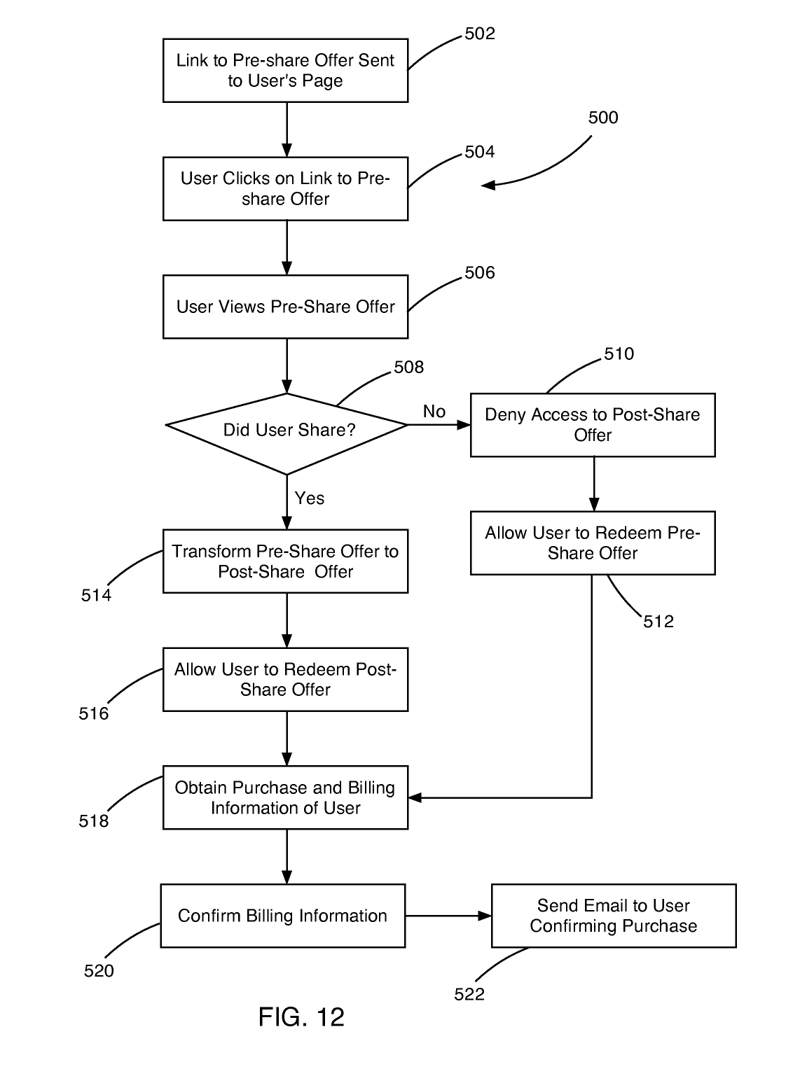

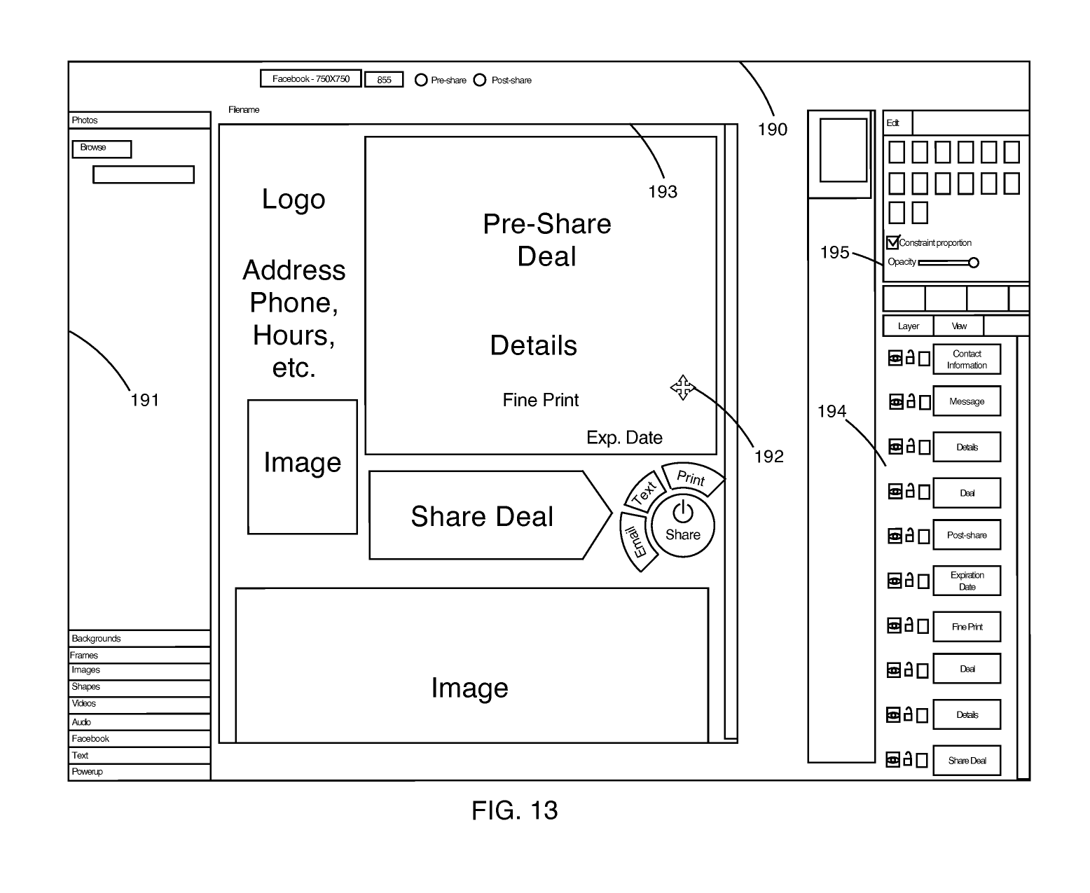

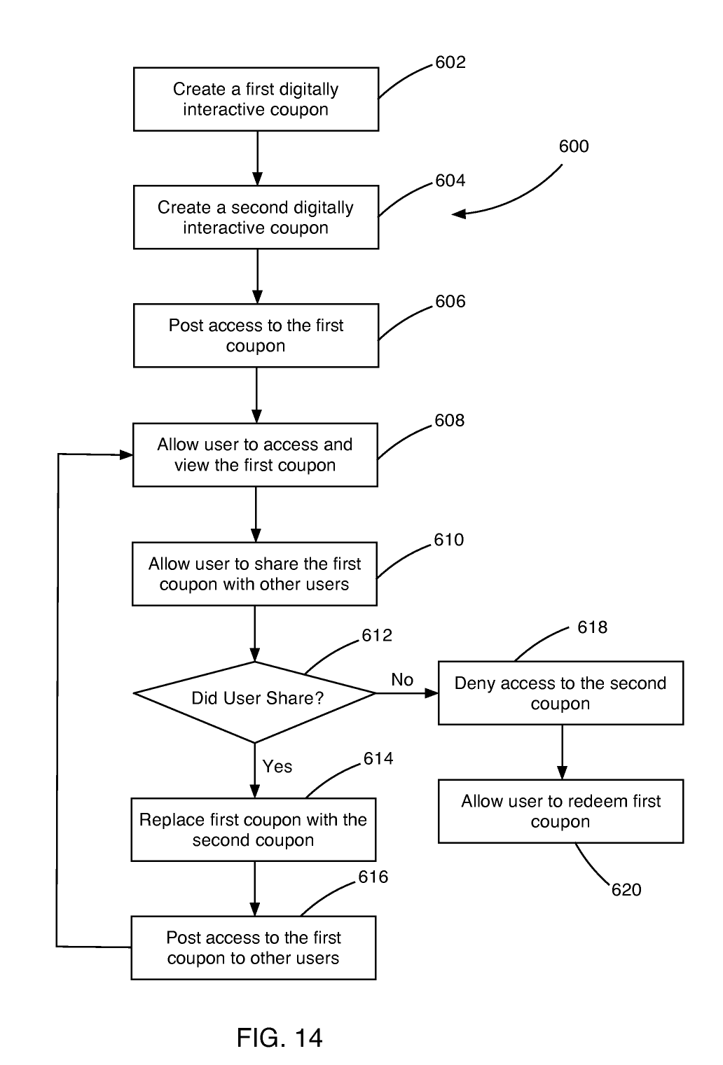

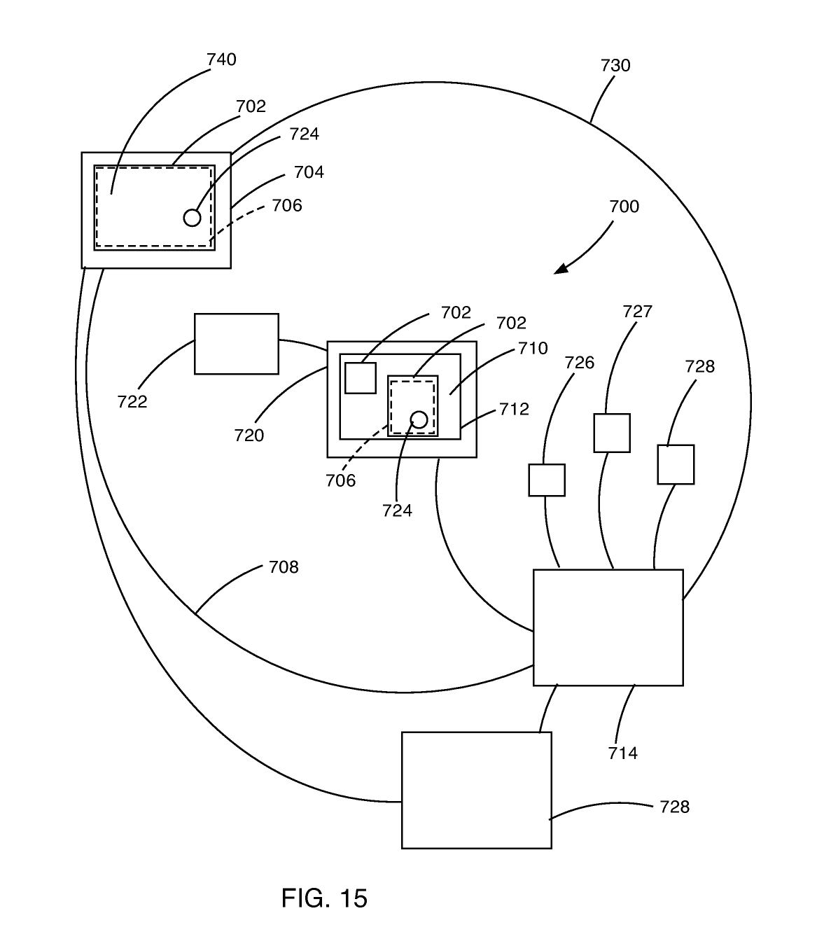

FIG. 9 is a flow diagram illustrating a computer software process for propagating advertising material in the form of a coupon through a social media environment. First, the vendor creates 302 a pre-share coupon. Next, the vendor creates 304 a post-share coupon. The Business Page Admin then posts 306 the pre-share coupon to fans of the vendor, which will then appear in the News Feed of the fans. A first user then clicks on the post, which in turn launches 308 the pre-share coupon. When the first user shares 310 the pre-share coupon, the pre-share coupon automatically transforms 312 into the post-share coupon for the first user that was created 304 by the vendor. The pre-share coupon is then automatically posted 314 on the wall of a second user who is a friend of the first user. For the purpose of further sharing of the pre-share coupon, the second user becomes the first user in which the second user will click 308 on the post to launch the pre-share coupon and, based on pre-set parameters imposed by the vendor in creating the pre-share and post-share coupons, can share the pre-share coupon to the friends of the second user to his or her friends in order to obtain access to the post-share coupon. Thus, this process can be repeated any number of times until the coupon expires, a certain number of the coupons have been shared or redeemed by users or based on other parameters that may be set by the vendor to limit the coupons (e.g., the coupon can only be shared a limited number of times.

As illustrated in FIG. 10, the technology developed in accordance with the principles of the present invention for a social media vendor system can also be employed to provide a system 400 for providing direct purchasing of products or services through a social media website. Again, once an offer is posted to a user on a social media website and the user selects the offer by clicking the offer, the user is directed to an interactive version 410 of the offer in which certain features (e.g., selectable fields) can be selected by the user. In particular, once the user views the purchase offer 412 in which an image of the product or image relating to the service being offered can be displayed as well as other textual material describing the service or product being offered, the user can click on the purchase button 414 in order to initiate a purchase of the product or service being offered for sale. Once the user clicks the purchase button 414, as shown in FIG. 11, the window 411 is transformed into a shopping cart. Various fields are provided to provide details regarding the item to be purchased, such as a shopping cart field 413, a billing information field 415 in which various sub-fields are provided that allow the user to input various billing information, such as a billing address and credit card information. Such sub-fields may include pull down menus for the state and credit card type to allow the user to select from a list. Once the user has entered their billing and shipping information, the user can click the confirm purchase button 417 to confirm the purchase to complete the transaction. While appearing to be within the media website environment, the entire purchasing transaction is hosted on a third party website so that the third party making the offer can verify the validity of the billing information provided and complete the purchase transaction directly with the user. This also helps to maintain security of confidential information that may be transmitted by the user, such as the user's credit card information. In addition, various security protocols may be provided to ensure that the purchase transaction is conducted in a safe manner to protect the confidential billing information of the user.

In order to incentivize the purchase according to the principles of the present invention, as illustrated in FIG. 12, the process 500 from initial viewing of the offer by the user to confirming the purchase can be several steps deep, starting with an initial incentivized offer in which the user is encouraged to share the offer with other users. Once a link to a pre-share offer is sent 502 to a user's social media page and the user clicks 504 on the link to the pre-share offer, which may be in the form of a digital image of the offer displayed on the user's social media wall, the user is directed to a page in which the user can view 506 the pre-share offer. As with other embodiments disclosed herein, the user can decide 508 whether to share the offer to other contacts of the user within the social media environment. If the user does not share the pre-share offer, the user is denied access to the post-share offer. In the case of purchasing a product, the incentive to share could be that the user that shares the pre-share offer is provided with a free shipping option that is not available to those that only utilize the pre-share offer to make a purchase. Unlike other Internet-based offers in which a code is provided that must be entered during checkout to obtain the offer, the incentivized offer, such as free shipping, is handled by the vendor or third party controlling the offer and only when the user actually shares the pre-share offer. That is, the third party vendor or administrator of the offer can control whether a user is entitled to the incentive since the incentive is only triggered when the user actually shares the pre-share offer with other users. This sharing feature is both detectable and trackable in real-time so that the incentive is properly applied and cannot be redeemed by other users that do not share the pre-share offer. Similar limitations and allowances can be placed on users who choose to email the pre-share offer with other users or for users who “like” the offer and become a fan of the vendor making the offer, thereby increasing the fan base of the vendor for future offers or incentives.

If the user fails to share the pre-share offer, the user is denied 510 access to the post-share offer but is allowed 512 to redeem the pre-share offer. When the user elects to redeem the pre-share offer, the user is prompted to provide purchase and billing information as with the window 411 shown in FIG. 11. If the user shares 508 the pre-share offer, the pre-share offer is transformed 514 into the post-share offer. If an incentive is provided in the post-share offer, the incentive is automatically included in the purchase. For example, a pre-share offer may provide a “buy one, get one half off” deal. The post-share offer may provide a “buy one, get one free” deal. Depending on which offer is redeemed by the user, the system will cause the user to purchase the appropriate offer without having to enter a code or take any other action in order to properly redeem the appropriate offer. The user is then allowed to redeem 516 the post-share offer. Once redeemed, such as by clicking a purchase button, the system provides prompts to obtain 518 the user's purchase and billing information. Once the user enters their billing, shipping and credit card information, the system will confirm 520 the billing information to ensure that the information is correct and that the credit card information is acceptable. Once confirmed, the system will send 522 an email to the user to confirm the purchase. The system then conveys the purchase to the vendor to have the vendor fulfill the order. Whether for purchasing products or services, the system 500 of the present invention can be employed to allow users to purchase products within a social media environment without being directed to a vendor's website. In addition, the system 500 could be used to offer various vouchers for purchasing goods or services using such vouchers. Thus, the present invention is not necessarily limited to the purchase of goods or services in a traditional sense. Essentially, whether the system of the present invention is used to purchase goods or services or to incentivize coupon sharing, the system as shown in FIG. 12 could be used, except rather than proceeding through the purchase process, the user is allowed to print or otherwise obtain a copy of the coupon, as by receiving the coupon as a digital image through a text, that can be redeemed at a later time. Indeed, the system of the present invention could be adapted to provide access to software downloads or apps for mobile devices and the like.

FIG. 14 illustrates a method 600 for incentivizing a user of a social media website to share an offer with other users of an online social media environment. The method includes the step of creating 602 a first digitally interactive coupon on a first computer device having a first layout with a first value. The first value is provided to the user regardless of whether or not the user shares the first coupon. The first coupon is provided with a clickable button that will transform the first coupon into a second coupon if the user agrees to and indeed does share the first coupon with other users of the social media website. The method further includes creating 604 a second digitally interactive coupon on the first computer device having a second value that is greater than the first value of the first coupon. The second coupon has a second layout that is similar to the first layout with information of the vendor, terms and conditions and options for redeeming the coupon, such as the ability to print, text or email the coupon. Once the first and second coupons are created, the vendor can post 606 access to the first coupon through an internet connection to a message board of a first user of a social media website hosted on a first server. It should be noted that reference to the term “server” as used herein is intended to cover one or more computing devices that is capable of hosting a website or web content, such as the social media website and that allows access by users to the online content, such as the social media website. As such, the term “server” is not intended to be limited to a single server, but may include a bank of servers or linked servers that may not necessarily be housed together.

A first user, to whom access to the first coupon has been provided, is allowed 608 to access and view the first coupon within the social media environment on a display device connected to a second computer device. The user is allowed 610 to share the first coupon with personal connections of the first user by clicking a share button provided with the first coupon. If the user shares 612 the first coupon, the first coupon is replaced with the second coupon when the first user clicks the share button and making the second coupon accessible only to the first user as a reward for sharing the first coupon. Once the user shares the first coupon, access to the first coupon is posted 616 to the message board of the plurality of users that have a personal connection to the user through the social media website. The process is then repeated for each additional user so long as the coupon campaign is made available. In each instance each user is allowed to access the first coupon without appearing to leave the social media website and each user is allowed to share the first coupon with a second plurality of personal connections of the first plurality of personal connections by clicking the share button within the first coupon. If any user fails to share the first coupon, that user is denied access 618 to the second coupon, but is allowed 620 to redeem the first coupon.

The method further includes hosting the first and second coupons on a second server that is separate from the first server. This allows the second server to track various analytics, such as the number of times the first user and the first and second plurality of personal connections have shared the first coupon through the second server.

Once the user shares or likes the offer, the user has thus authorized the vendor to send information to the first user through the social media website by posting the information on the first user's message board. That is, sharing the first coupon by a user that receives the first coupon creates a link or personal connection between the user and the vendor that will allow the vendor to post future coupon offers directly to the message board of the user, where no such ability previously existed. When the first user to access the first coupon without appearing to leave the social media website comprises viewing the first coupon in a web browser window on the display device that is connected to the social media website. Once the coupon is shared, the first coupon is automatically replaced with the second coupon by visually transforming the first coupon into the second coupon within the web browser window displayed on the display device that the first user is using to view the first coupon. This can be accomplished by FLASH, HTML, JAVA or other web-based programming protocols.

As previously discussed, when creating the coupon offers, a coupon generating system that is operating on vendor accessible server is provided for creating the first and second coupons. The software application provides a user interface with user selectable coupon fields that allows the vendor to create the first and second coupons and post the first and second coupons to users. The coupon generating software application includes a plurality of vendor selectable templates for creating the first and second coupons. The vendor can thus select from a menu of preconfigured coupon layouts rather than requiring the vendor to create a coupon or offer from scratch. In other embodiments, the coupon generating software allows a vendor to generate a completely customizable coupon where each field is sizable, movable and the content of which can be anything from text to video to images.

As illustrated in FIG. 15, an incentivized coupon distribution system 700 for incentivizing a user of a social media web cite to share an offer with others within an online social media environment is illustrated. The system 700 includes a first digitally interactive coupon 702 displayed on a first computing device 704 having a first layout with a first value. A second digitally interactive coupon 706 is displayed on the first computing device having a second value that is greater than the first value of the first coupon. The second coupon has a second layout that is similar to the first layout. The first coupon posted through an Internet connection 708 to a message board 710 of a first user of a social media website 712 hosted on a first server 714. The first coupon 702 is viewable on a display device 720 connected to a second computer device 722 by a first user of the social media website.

The first coupon has a share button 724 so as to be sharable by the first user with personal connections to other users when the first user clicks the share button 724 of the first coupon 702. When the user clicks the share button 724, the second coupon 706 replaces the first coupon 702 on the display device 720. Clicking the share button 724 also cause the first coupon 702 to be send to other users accounts 726, 727 and 728 that are connected to the server 714 and that are personal contacts of the first user. Thus, when the first user clicks the share button 724, the second coupon 706 becomes accessible by the first user as a reward for sharing the first coupon 702. In addition, the first coupon 706 is automatically posted to the message boards of a first plurality of personal connections of the first user when the first user clicks the share button 724.

The first coupon 702 is accessible by the first plurality of personal connections 726, 7272 and 728 of the first user without appearing to leave the social media website 712. Once the first coupon is distributed to the first plurality of users 726, 727 and 728, the first coupon 702 can be further shared with a second plurality of personal connections of the first plurality of personal connections 726, 727 and 728 by clicking the share button 724 of the first coupon 702. The first coupon 702 is automatically replaced with the second coupon 706 when any of the first plurality of personal connections 726, 727 and 728 clicks the share button 724 and the second coupon 706 becomes accessible to the first plurality of personal connections 726, 727 and 728 as a reward for sharing the first coupon 702. The first coupon 702 is also shareable with a second plurality of personal connections of the first plurality of personal connections 726, 727 and 728 when any of the first plurality of personal connections 726, 727 and 728 clicks the share button 724 of the first coupon 702. When any of the first plurality of personal connections 726, 727 and 728 clicks the share button 724 of the first coupon 702, the first coupon 702 is then posted on the message boards of the second plurality of personal connections of the first plurality of personal connections 726, 727 and 728 when any of the first plurality of personal connections 726, 727 and 728 clicks the share button 724.

The system 700 includes a second server 728 that is separate from the first server 714 for hosting the first and second coupons. The second server 728 is connected to the first computing device 704 for receiving the first and second coupons and communicating with the first server 714 to post and host the first and second coupons according to the above-described sharing protocol. The second server is also configured for tracking the number of times the first user and the first and second plurality of personal connections have shared the first coupon and can relay that information to the first computing device 704 for viewing by the vendor. The first computer 704 is employed to initiate the posting of the first coupon to the message board of the first user if the first user has authorized the vendor to send information to the first user through the social media website.

A personal connection 730 via the social media website is created by sharing the first coupon 702 by a user that receives the first coupon between the user 726, 727 or 728 and the vendor allowing the vendor to post additional coupon offers directly to the message board of the user. The display devices of each user display the first coupon in a web browser. The web browser web browser allows the first user to access the first coupon without appearing to leave the social media website. In addition, when shared, the first coupon is automatically replaced with the second coupon by being visually transformed from the first coupon into the second coupon within the web browser window displayed on the display device.

The vendor may be provided with access to a coupon generating system 740 configured to operating on a vendor accessible server for creating the first and second coupons 702 and 706, respectively. The coupon generating system 740 is configured to prove a user interface with user selectable coupon fields that allow the vendor to create the first and second coupons and post the first and second coupons to the first user, as previously described herein.

In the foregoing specification, the present invention has been described with reference to specific exemplary embodiments. Various modifications and changes may be made, however, without departing from the spirit and scope of the present invention as set forth in the claims. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “Wall”, “Bulletin Board”, “message board”, or other social media specific terms are intended to reference any social media website user page where news items, bulletins or other postings are posted to a user's personal page for viewing by the user. Thus, while various terms used herein, including use in the claims, may be specifically associated with a particular social media site, it is intended that such terms as may be used herein and in the claims are to be given their broadest interpretation to cover any social media site unless expressly limited herein. The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A method for incentivizing a user of a social media website to share an offer with others within an online social media environment, comprising:
creating a first digitally interactive coupon on a first computer device having a first layout with a first value;
creating a second digitally interactive coupon on the first computer device having a second value that is greater than the first value of the first coupon, the second coupon having a second layout that is similar to the first layout;
posting the first coupon through an internet connection to a message board of a first user of a social media website hosted on a first server;
allowing the first user to access and view the first coupon within the social media environment on a display device connected to a second computer device;
allowing the first user to share the first coupon with personal connections of the first user by clicking a share button within the first coupon;
replacing the first coupon with the second coupon when the first user clicks the share button and making the second coupon accessible only to the first user as a reward for sharing the first coupon;
sharing the first coupon with a first plurality of personal connections of the social media website of the first user when the first user clicks the share button;
posting the first coupon on the message board of the first plurality of personal connections of the first user when the first user clicks the share button;
allowing each of the first plurality of personal connections to access the first coupon without appearing to leave the social media website;
allowing the first plurality of personal connections to share the first coupon with a second plurality of personal connections of the first plurality of personal connections by clicking a share button within the first coupon;
replacing the first coupon with the second coupon when the first plurality of personal connections clicks the share button and making the second coupon accessible only to the first plurality of personal connections as a reward for sharing the first coupon;
sharing the first coupon with a second plurality of personal connections of the first plurality of personal connections when the first plurality of personal connections each click the share button; and
posting the first coupon on the message board of the second plurality of personal connections of the first plurality of personal connections when the first plurality of personal connections each click the share button.

2. The method of claim 1, further comprising hosting the first and second coupons on a second server that is separate from the first server.

3. The method of claim 2, further comprising tracking the number of times the first user and the first and second plurality of personal connections have shared the first coupon through the second server.

4. The method of claim 1, further comprising allowing a vendor to create the first coupon and the second coupon on the first computer and wherein the first user has authorized the vendor to send information to the first user through the social media website by posting the information on the first user's message board.

5. The method of claim 4, wherein sharing the first coupon by a user that receives the first coupon creates a personal connection between the user and the vendor that will allow the vendor to post additional coupon offers directly to the message board of the user.

6. The method of claim 1, wherein allowing the first user to access the first coupon without appearing to leave the social media website comprises viewing the first coupon in a web browser window on the display device that is connected to the social media website.

7. The method of claim 6, wherein replacing the first coupon with the second coupon comprises visually transforming the first coupon into the second coupon within the web browser window displayed on the display device that the first user is using to view the first coupon.

8. The method of claim 4, further comprising providing a coupon generating system operating on vendor accessible server for creating the first and second coupons, the software application providing a user interface with user selectable coupon fields that allow the vendor to create the first and second coupons and post the first and second coupons to the first user.

9. The method of claim 8, wherein the providing a coupon generating software application further comprises providing a plurality of vendor selectable templates for creating the first and second coupons.

10. The method of claim 4, wherein the second plurality of personal connections are provided access to the second coupon when the second plurality of personal connections share the first coupon via the first server.

11. An incentivized coupon distribution system for incentivizing a user of a social media website to share an offer with others within an online social media environment, comprising:
a first digitally interactive coupon on a first computer device having a first layout with a first value;
a second digitally interactive coupon on the first computer device having a second value that is greater than the first value of the first coupon, the second coupon having a second layout that is similar to the first layout;
the first coupon posted through an internet connection to a message board of a first user of a social media website hosted on a first server;
the first coupon being viewable on a display device connected to a second computer device by a first user of the social media environment;
the first coupon having a share button and being sharable by the first user with personal connections when the first user clicks the share button of the first coupon;
the second coupon replacing the first coupon when the first user clicks the share button and the second coupon being accessible by the first user as a reward for sharing the first coupon;
the second coupon being automatically posted to the message boards of a first plurality of personal connections of the first user when the first user clicks the share button;
the first coupon being accessible by the first plurality of personal connections of the first user without appearing to leave the social media website;
the first coupon being sharable by the first plurality of with a second plurality of personal connections of the first plurality of personal connections by clicking the share button of the first coupon;
the first coupon being automatically replaced with the second coupon when any of the first plurality of personal connections clicks the share button and the second coupon being accessible to the first plurality of personal connections as a reward for sharing the first coupon;
the first coupon being shareable with a second plurality of personal connections of the first plurality of personal connections when any of the first plurality of personal connections clicks the share button of the first coupon; and
the first coupon being posted on the message boards of the second plurality of personal connections of the first plurality of personal connections when any of the first plurality of personal connections clicks the share button.

12. The system of claim 11, further comprising a second server that is separate from the first server for hosting the first and second coupons.

13. The system of claim 12, wherein the second server is configured for tracking the number of times the first user and the first and second plurality of personal connections have shared the first coupon.

14. The system of claim 11, wherein the first computer is configured to allow a vendor to create the first coupon and the second coupon and wherein the first user has authorized the vendor to send information to the first user through the social media website by posting the information on the first user's message board.

15. The system of claim 14, further comprising a personal connection via the social media website created by sharing the first coupon by a user that receives the first coupon between the user and the vendor allowing the vendor to post additional coupon offers directly to the message board of the user.

16. The system of claim 11, wherein the display device displays the first coupon in a web browser and wherein the web browser allows the first user to access the first coupon without appearing to leave the social media website.

17. The system of claim 16, wherein the display device displays the first coupon and the first coupon is automatically replaced with the second coupon by being visually transformed from the first coupon into the second coupon within the web browser window displayed on the display device.

18. The system of claim 14, further comprising providing a coupon generating system configured to operating on a vendor accessible server for creating the first and second coupons, the coupon generating system configured to prove a user interface with user selectable coupon fields that allow the vendor to create the first and second coupons and post the first and second coupons to the first user.

19. The system of claim 18, wherein the coupon generating system further comprises a plurality of vendor selectable templates for creating the first and second coupons.

20. The system of claim 14, wherein the second plurality of personal connections have access to the second coupon when the second plurality of personal connections share the first coupon via the first server.
